(19) United States
(12) Patent Application Publication
(10) Pub. No.: US 2017/0130408 A1
(43) Pub. Date: May 11, 2017

(54) Portable Heating Assembly Using Carbon Crystal Mica Heating Plates for In Situ Asphalt Road Renewal

(71) Applicant: Smart EPC Ltd., Calgary (CA)

(72) Inventors: Chengshan ZHANG, Vancouver (CA); Weihong HAN, Beijing (CN); Wei ZHANG, Beijing (CN)

(21) Appl. No.: 15/053,815

(22) Filed: Feb. 25, 2016

(30) Foreign Application Priority Data
Nov. 6, 2015 (CN) 201520884196.5

(51) Int. Cl. E01C 23/14; E01C 11/00; H05B 3/28; E01C 23/06

(52) U.S. Cl. CPC E01C 23/14; E01C 23/065; E01C 11/005; H05B 3/283; E01C 2301/10; H05B 2203/032

(57) ABSTRACT

There is provided a portable heating assembly for in situ asphalt road renewal. The assembly includes a housing with a top wall and a plurality of side walls coupled to and extending downwards from the top wall. The top and side walls include insulating material therewithin. The housing has an open end spaced-apart below the top wall. The assembly includes at least one heating plate coupled to the housing and in communication with the open end of the housing. The heating plate is between the side walls. The heating plate is a carbon crystal mica heating plate in one embodiment.

### RELATED APPLICATIONS

This application claims priority to Chinese Patent Application No. CN 201520427486.7, filed Oct. 29, 2015, which is incorporated herein by reference in its entirety.

### FIELD OF THE INVENTION

There is provided a portable heating assembly. In particular, there is provided a portable heating assembly using carbon crystal mica plates for in situ asphalt road renewal.

### BACKGROUND OF THE INVENTION

U.S. Patent Application Publication No. 2011/0250016 A1 to Giles discloses a multipurpose asphalt processor and method for repairing damaged asphalt. The asphalt processor may be used to both till and screed asphalt surfaces. The asphalt processor may include a powered shaft having a plurality of tines extending therefrom. The outermost tines on the shaft may be angled to thereby form a beveled surface along the edges of a tilled area of asphalt. The asphalt processor may further include a screed for leveling tilled asphalt. The asphalt processor may take the form of an attachment for use with existing machinery, such as a tractor.

U.S. Pat. No. 3,801,212 to Cutler et al. discloses a heater for asphalt concrete repaving apparatus that utilizes fuel, such as pentane, to direct a flame onto a radiant heating element. The flame is redirected radially outwardly along the radiant heating element so the flame will not impinge on the road surface and only radiant heat is used. Such radiant heat will allegedly penetrate the road surface to a depth of 1 inch or more in a relatively short period of time whereupon the heated and softened asphalt together with portions thereof beneath the heated portion are excavated. Additional heat is applied to the excavated material to further soften it and small lies of new asphalt material may be added if desired before the reworked material is again laid to form a road surface.

### SUMMARY OF THE INVENTION

There is provided an improved portable heating assembly for in situ asphalt road renewal.

According to one aspect, there is provided a portable heating assembly for in situ asphalt road renewal. The assembly includes a housing with a top wall and a plurality of side walls coupled to and extending downwards from the top wall. The top and side walls include insulating material therewithin. The housing has an open end spaced-apart below the top wall. The assembly includes at least one heating plate coupled to the housing and in communication with the open end of the housing. The heating plate is between the side walls.

There is also provided a portable heating assembly for in situ asphalt road renewal. The assembly includes a housing have an open end. The assembly includes at least one carbon crystal mica heating plate coupled to and enclosed in part by the housing. The heating plate is connectable to a power supply and is in communication with the open end of the housing.

There is further provided a vehicle for in situ asphalt road renewal. The vehicle has a front end and a rear end. The vehicle includes any one of the above set out portable heating assemblies. The portable heating assembly couples to a first one of the ends of the vehicle. The vehicle includes an asphalt rejuvenating processor for rejuvenating asphalt heated by the portable heating assembly. The processor is coupled to a second one of the ends of the vehicle. The vehicle includes a portable generator which functions to power the portable heating assembly and asphalt rejuvenating processor.

### BRIEF DESCRIPTION OF THE DRAWINGS

The invention will be more readily understood from the following description of preferred embodiments thereof given, by way of example only, with reference to the accompanying drawings, in which:

FIG. 1 is a front, side perspective view of a vehicle for in situ asphalt road renewal, the vehicle including a portable heating assembly according to one aspect coupled thereto, the portable heating assembly being shown in a lower, deployed position;

FIG. 2 is a front, side perspective view the vehicle of FIG. 1, with the portable heating assembly being shown in a raised, stored position;

FIG. 3 is a bottom, side perspective view of the portable heating assembly of FIG. 1 and the vehicle of FIG. 1 shown in fragment, the portable heating assembly including a housing having an outer shell, inlet covers hingedly connected to side walls of the housing, the inlet covers being in partial open positions and a grid assembly at an open end thereof;

FIG. 4 is a top, front perspective view of the portable heating assembly of FIG. 3, with the outer shell of FIG. 3 being removed;

FIG. 5 is a bottom plan view of the portable heating assembly of FIG. 4, with the inlet covers being shown in closed positions, the heating assembly including a plurality of heating plates, and with the grid assembly of the housing not being shown;

FIG. 6 is a cross-sectional elevation view of the portable heating assembly of FIG. 5 taken along lines 6-6 of the assembly shown in FIG. 5;

FIG. 7 is a cross-sectional elevation view of the portable heating assembly of FIG. 4 taken along lines 7-7 of the assembly shown in FIG. 5;

FIG. 8 is an enlarged view of one of the heating plates of the portable heating assembly shown in FIG. 7, together with a mounting brackets coupled thereto according to one aspect;

FIG. 9 is a schematic, bottom view of the portable heating assembly of FIG. 1;

FIG. 10 is a schematic, elevation view of a vehicle for in situ asphalt road renewal according to a second aspect, the vehicle including an asphalt rejuvenating processor, a vibratory drum roller, a power generator, and a portable heating assembly, the heating assembly being shown in a stored position;

FIG. 11 is a top, side perspective view of the portable heating assembly of FIG. 10 partially shown in cross-section and shown in fragment with the front and rear walls of the assembly being not shown, the heating assembly being shown in a deployed position;

FIG. 12 is a side perspective view of a portable heating assembly for in situ asphalt road renewal according to a third aspect, the assembly being for use with the vehicle shown in FIG. 1 and the inlet covers of the assembly being shown in partially open positions to reveal heating plates and mounting brackets of the assembly within the interior of the housing the assembly; and

FIG. 13 is a bottom plan view of the portable heating assembly of FIG. 12.

### DETAILED DESCRIPTION OF THE PREFERRED EMBODIMENTS

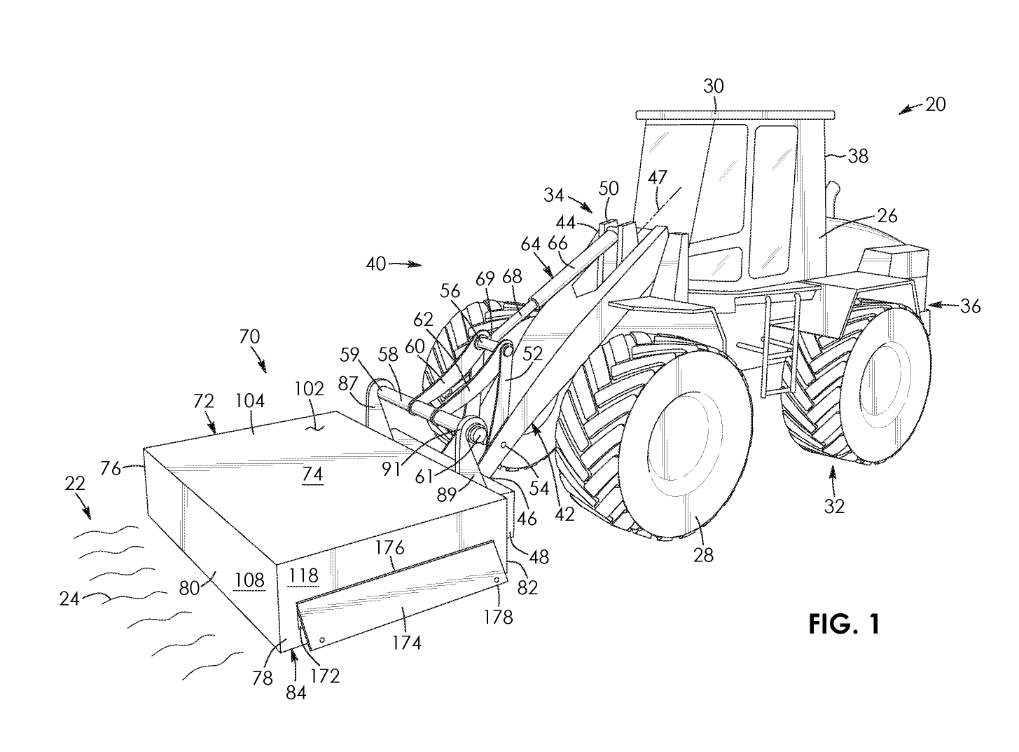

Referring to the drawings and first to FIG. 1, there is shown a vehicle 20 for in situ road renewal, in this example renewal of road 22 made of asphalt 24. The vehicle in this example is in the form of a wheel loader.

The vehicle includes a body 26 and a plurality of ground-engaging wheels, as shown by wheel 28, rotatably coupled to the body. The vehicle 20 has a top 30, a bottom 32 opposite the top, a pair of spaced-apart sides 34 and 36, a first or rear end 38 and a second or front end 40 spaced-apart from the rear end. The sides of the vehicle extend between the top and the bottom of the vehicle and between the front and rear ends of the vehicle. The rear end 38 and front end 40 of the vehicle extend between the top 30 and bottom 32 of the vehicle.

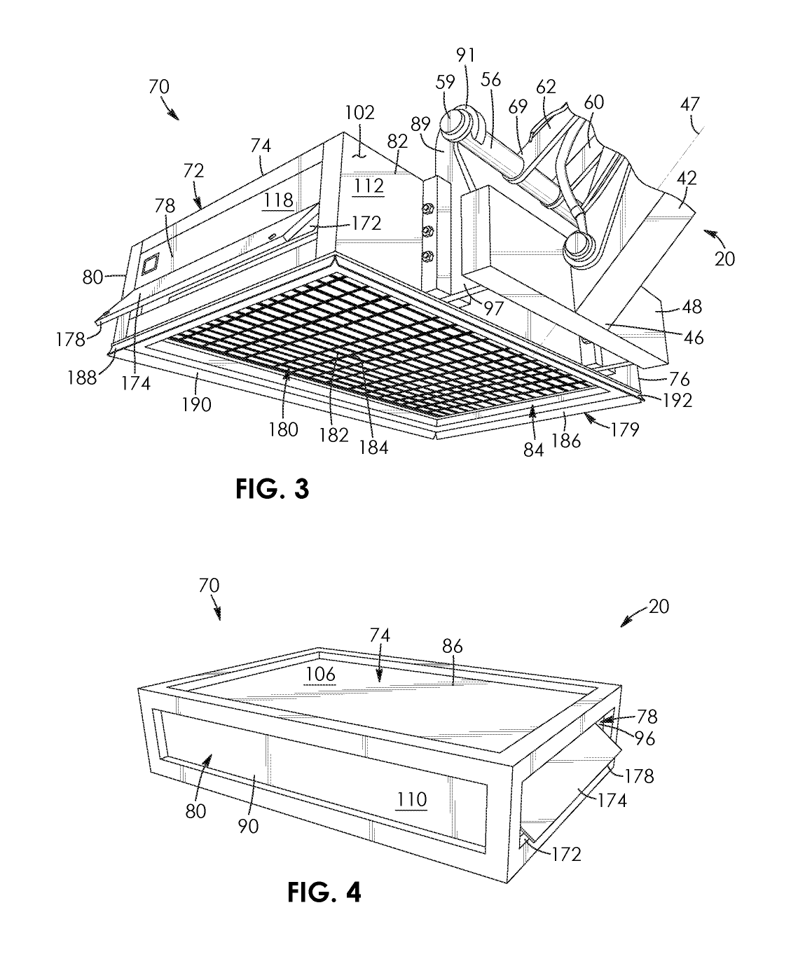

The vehicle 20 includes an elongate arm 42 having a proximal end 44 coupled to and extending from the body 26 adjacent to the front end 40 of the vehicle in this example. In this example the arm slants downwards from the body of the vehicle 20. The arm 42 has a distal end 46 spaced-apart from the proximal end thereof and a longitudinal axis 47 extending between the proximal and distal ends thereof. A plate member 48 couples to the distal end of the arm in this example. As best seen in FIG. 3, the plate member is substantially a rectangular prism in this example.

Referring back to FIG. 1, the vehicle 20 includes a first bracket 50 coupled to and extending upwards from the arm 42 adjacent to the proximal end 44 of the arm. The vehicle includes a second bracket 52 extending upwards from and pivotally connected to the arm via a pivot 54 located adjacent to the distal end 46 of the arm.

The vehicle 20 includes a pair of spaced-apart rods 56 and 58 pivotally connected together via a pair of spaced-apart elongate linking members 60 and 62. As seen in FIG. 1, the rods extend laterally relative to the longitudinal axis 47 of the arm 42 in this example. Rod 56 extends between and is pivotable about bracket 52. Rod 58 extends outwards from rod 56 in this example and has a pair of spaced-apart ends 59 and 61.

As seen in FIG. 1, the vehicle 20 includes an actuator, in this example a hydraulic actuator 64. The actuator includes a piston cylinder 66 pivotally connected to bracket 50 and a piston rod 68 shaped to be partially received by the cylinder for reciprocating connection therewith. The distal end 69 of the piston rod is thus operatively pivotally connected to the bracket 52.

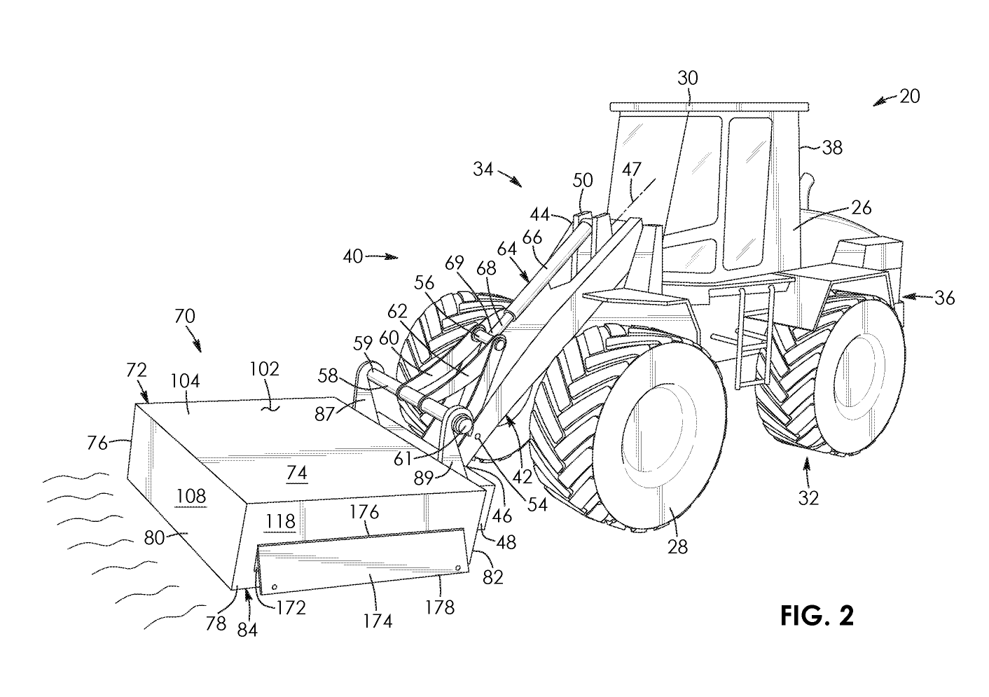

The piston rod 68 has an extended position seen in FIG. 1, in which bracket 52 is in a first angular position and in which rod 58 aligns with and is positioned above plate member 48 in this example. The piston rod is moveable from the extended position to a retracted position seen in FIG. 2. The bracket 52 is in a second angular position in the retracted position shown in FIG. 2 that is angularly spaced-apart from the first angular position. Bracket 52 is positioned closer to the arm 42 and proximal end 44 of the arm when the bracket moves from the first angular position to the second angular position seen in FIG. 2. Rod 58 and link members 60 and 62 are positioned towards the proximal end of the arm in the retracted position of the piston rod 68.

As seen in FIG. 1, the vehicle 20 includes a portable heating assembly 70 in this example. However, in other examples, the assembly may be a separate component that is connectable to the vehicle. The assembly 20 includes a housing 72 that is generally a rectangular prism in shape in this example. The housing comprises a top wall 74, a pair of spaced-apart side walls 76 and 78, a further side or front wall 80 and an additional side or rear wall 82. The side, front and rear walls couple to and extend downwards from the top wall of the housing in this example. Side walls 76 and 78 are rectangular and are generally substantially similar in shape in this example. Front wall 80 and rear wall 82 are rectangular and generally substantially in shape in this example. As seen in FIG. 3, the housing 72 has a bottom end, in this example a bottom, open end 84 spaced-apart below the top wall 74 thereof.

The side walls 76 and 78, the front wall 80 and the rear wall 82 of the housing extend between the top wall 74 and the open end 84 of the housing. Side walls 76 and 78 of the housing 72 align and extend in parallel with the sides 34 and 36 of the vehicle 20, respectively, in this example when the vehicle 20 aligns in substantially straight manner. The front wall 80 and rear wall 82 of the housing extend between the side walls of the housing in this example.

As seen in FIG. 1, the portable heating assembly 70 include a pair of spaced-apart hook members 87 and 89 in this example coupled to and extending upwards from the rear wall 82 of the housing 72. The hook members have hook-shaped portions, as seen by hook-shaped portion 91 for hook member 89, that are shaped to selectively receive and thus couple to rod 58 via ends 59 and 61 of the rod. In this manner, the portable heating assembly 70 is selectively connectable to arm 42 and thus vehicle 20. In this manner, the assembly 70 may interface with a backhoe loader, for example, thereby facilitating use of the assembly and transportation thereof. Referring to FIG. 3, each of the hook members 89 has an elongate base portion 97 that is a rectangular prism in shape in this example. The base portions of the hook members 87 and 89 are shaped to abut plate member 48 in this example when the portable heating assembly 70 is coupled to arm 42.

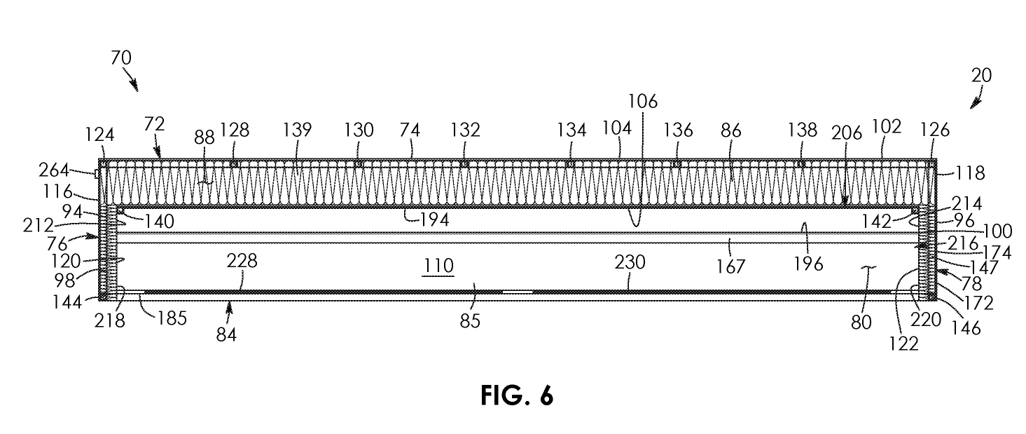

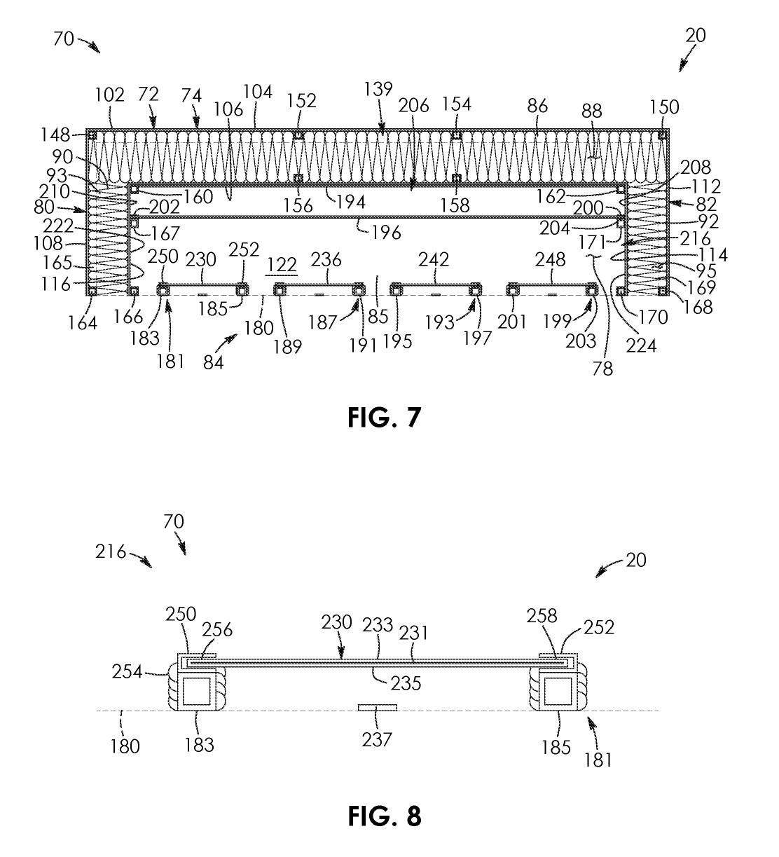

As seen in FIGS. 6 and 7, the housing 72 has an interior 85 enclosed by the top wall 74, side walls 76 and 78, front wall 80 and rear wall 82 thereof.

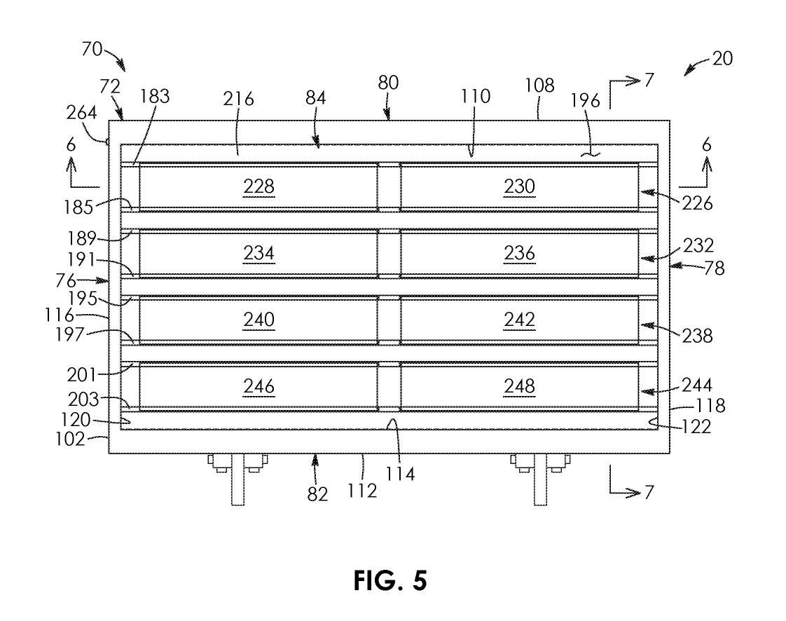

Referring to FIG. 4, top wall 74 has a recess 86 that is a rectangular prism in shape in this example. Referring to FIG. 5, an insulating material, in this example in the form of mineral wool 88, is disposed within and fills recess 86 of the top wall of the housing 72 in this example. As seen in FIGS. 4 and 7, the front wall 80 and rear wall 82 have recesses 90 and 92, respectively, each of which is a rectangular prism in shape in this example. As seen in FIG. 7, insulating material, in this example in the form of mineral wool 93 and 95, is disposed within and fills recesses 90 and 92 of the front and rear walls of the housing 72 in this example.

As seen in FIGS. 4 and 6, each of the side walls 76 and 78 has recesses 94 and 96, each of which is a rectangular prism in shape in this example. As seen in FIG. 6, insulating material in this example in the form of mineral wool 98 and 100 is disposed within and fills recesses 94 and 96 of the side walls of the housing 72 in this example.

As seen in FIG. 1, the housing includes an outer shell 102, in this example of sheet metal, extends about and encloses the recesses of the top wall 74, side walls 76 and 78, front wall 80 and rear wall 82 of the housing 72. The shell is a part of the walls of the housing in this example. As seen in FIG. 7, the top wall 74 of the housing 72 has an outer portion 104 and an inner portion 106 spaced-apart from the outer portion. Mineral wool 88 is interposed between the inner and outer portions of the top wall of the housing in this example.

The front wall 80 has an outer portion 108 coupled to and extending downwards from the outer portion 104 of top wall 74. The front wall has inner portion 110 spaced-apart from the outer portion thereof. The inner portion of the front wall 80 couples to and extends downwards from the inner portion 106 of the top wall 74 of the housing 72 to open end 84 of the housing. Mineral wool 93 is interposed between the inner and outer portions of the front wall of the housing in this example.

The rear wall 82 has an outer portion 112 coupled to and extending downwards from the outer portion 104 of top wall 74. The rear wall has inner portion 114 spaced-apart from the outer portion thereof. The inner portion of the rear wall 82 couples to and extends downwards from the inner portion 106 of the top wall 74 of the housing 72. Mineral wool 95 is interposed between the inner and outer portions of the rear wall of the housing in this example.

As seen in FIG. 6, side walls 76 and 78 have outer portions 116 and 118 coupled to and extending downwards from the outer portion 104 of top wall 74. The side walls 76 and 78 have inner portions 120 and 122 spaced-apart from the outer portions thereof. The inner portions of the side walls couple to and extend downwards from the inner portion 106 of the top wall 74 of the housing 72. As seen in FIGS. 6 and 7, inner portions 106, 114, 116, 120, and 122 of the top wall 74, rear wall 82, front wall 80, and side walls 76 and 78, respectively, may collectively be referred to as an inner shell, with the housing 72 thus comprising a double-shell wall structure. Mineral wool 98 is interposed between the inner portion 120 and outer portion 116 of side wall 76 of the housing 72 in this example. Mineral wool 100 is interposed between the inner portion 122 and outer portion 118 of side wall 78 of the housing in this example.

As seen in FIG. 5, the outer portions 108, 112, 116, and 118 and inner portions 110, 114, 120 and 122 of the front wall 80, rear wall 82, side wall 76 and side wall 78, respectively, are made of high-strength stainless steel in this example. However, this is not strictly required and the inner and outer portions of the walls may be made of other materials in other examples.

As seen in FIG. 6, the top wall 74 of the housing 72 includes a first pair of spaced-apart, laterally-extending, peripheral elongate members, in this example square peripheral tubes 124 and 126 coupled to the outer portion 104 thereof in this example via welding. Tube 124 also couples to outer portion 116 of side wall 76 of the housing in this example and tube 126 additionally couples to outer portion 118 of side wall 78 of the housing in this example. The top wall 74 of the housing includes a plurality of spaced-apart, laterally-extending, inner elongate members, in this example square tubes 128, 130, 132, 134, 136, and 138 interposed between peripheral tubes 124 and 126 and coupled to the outer portion 104 thereof in this example via welding. Tubes 124, 126, 128, 130, 132, 134, 136 and 138 are positioned within the interior 139 of the top wall of the housing in this example.

The top wall 74 of the housing 72 includes a second pair of spaced-apart, laterally-extending, peripheral elongate members, in this example square peripheral tubes 140 and 142 coupled to the inner portion 106 thereof in this example via welding. Tube 140 also couples to inner portion 120 of side wall 76 of the housing in this example via welding and tube 126 additionally couples to inner portion 122 of side wall 78 of the housing in this example via welding. Tubes 140 and 142 are in communication with the interior 85 of the housing 72 in this example.

Side wall 76 of the housing 72 includes an additional laterally-extending, peripheral elongate member, in this example square peripheral tube 144 coupled to outer portion 120 thereof via welding and disposed within the interior 145 thereof in this example. Side wall 78 of the housing includes additional laterally-extending, peripheral elongate member, in this example square tube 146 coupled to outer portion 118 thereof via welding and disposed within the interior 147 thereof in this example. Tubes 144 and 146 extend adjacent to the open end 84 of the housing 72 in this example. The laterally-extending tubes 124, 126, 128, 130, 132, 134, 136, 138, 140, 142, 144 and 146 extend between the front wall 80 and the rear wall 82 of the housing 72 seen in FIG. 5 in this example.

Referring now to FIG. 7, the top wall 74 of the housing 72 includes a first pair spaced-apart, longitudinally-extending peripheral elongate members, in this example, square peripheral tubes 148 and 150 coupled to the outer portion 104 thereof via welding. Tube 148 also couples to outer portion 110 of front wall 80 of the housing via welding and tube 150 additionally couples to outer portion 112 of rear wall 82 of the housing via welding. The top wall 74 of the housing includes a first pair of spaced-apart, longitudinally-extending, inner elongate members, in this example, square tubes 152 and 154 coupled to the outer portion 104 thereof via welding. Longitudinally-extending tubes 148, 150, 152 and 154 couple and intersect with laterally-extending tubes 124, 126, 128,130, 132, 134, 136 and 138 seen in FIG. 6 in this example. Referring back to FIG. 7, the top wall 74 of the housing 72 includes a second pair of spaced-apart, longitudinally-extending inner elongate members, in this example, square, tubes 156 and 158 coupled to the inner portion 106 thereof via welding. Tube 156 aligns with and is spaced-apart below tube 152 in this example and tube 158 aligns with and is spaced-apart below tube 154 in this example. Tubes 148, 150, 152, 154, 156 and 158 are positioned within the interior 139 of the top wall 74 of the housing 72 in this example.

The top wall of the housing includes a second pair of spaced-apart, longitudinally-extending, peripheral elongate members, in this example square peripheral tubes 160 and 162 coupled to the inner portion 106 thereof via welding. Tube 160 also couples to inner portion 110 of front wall 80 of the housing 72 in this example via welding and tube 162 additionally couples to inner portion 114 of rear wall 82 of the housing in this example via welding.

Front wall 80 of the housing 72 includes additional longitudinally-extending, peripheral elongate member, in this example square peripheral tube 164 coupled to outer portion 108 thereof via welding and disposed within the interior 165 thereof in this example. The front wall of the housing includes a further longitudinally-extending, inner elongate member, in this example, square tube 166 coupled to inner portion 110 thereof via welding. The front wall 80 of the housing 72 includes a yet further longitudinally-extending, inner elongate member, in this example, square tube 167 coupled to the inner portion 110 thereof via welding. Tube 167 is interposed between tubes 160 and 166 in this example.

Rear wall 82 of the housing 72 includes additional longitudinally-extending, peripheral elongate member, in this example square peripheral tube 168 coupled to outer portion 112 thereof via welding and disposed within the interior 169 thereof in this example. The rear wall of the housing includes a further longitudinally-extending, inner elongate member, in this example square peripheral tube 170 coupled to inner portion 114 thereof via welding. The rear wall 82 of the housing 72 includes a yet further longitudinally-extending, inner elongate member, in this example, square tube 171 coupled to the inner portion 112 thereof via welding. Tube 171 is interposed between tubes 162 and 170 in this example.

As seen in FIG. 7, the portable heating assembly 70 further includes a plurality of longitudinally-extending pairs of inner elongate members, in this example square heating-plate mounting tubes in the form of a first pair 181 of tubes 183 and 185, a second pair 187 of tubes 189 and 191, a third pair 193 of square tubes 195 and 197, and a fourth pair 199 of square tubes 201 and 203. These tubes are positioned within the lower chamber 216 of the housing 72. Pair 181 of tubes 183 and 185 are positioned adjacent to front wall 80 in this example. Pair 199 of tubes 201 and 203 are positioned adjacent to rear wall 82 in this example. The pairs 187 and 193 of the tubes are between pairs 181 and 199 of the tubes. As seen in FIG. 5, tubes 183, 185, 189, 191, 195, 197, 201 and 203 extend between and couple to inner portions 120 and 122 of side walls 76 and 78 of the housing 72 via welding in this example. As seen in FIG. 7, tubes 164, 166, 168, 170, 183, 185, 189, 191, 195, 197, 201 and 203 align and extend adjacent to the open end 84 of the housing 72 in this example.

Tubes 160, 162, 166, 167, 170, 171, 183, 185, 189, 191, 195, 197, 201 and 203 are in communication with the interior 85 of the housing in this example. The longitudinally-extending tubes 148, 150, 152, 154, 156, 158, 160, 162, 164, 166, 167, 168, 170 and 171 extend between the side walls 76 and 78 of the housing 72 seen in FIG. 6 in this example. Each of the tubes referred to herein is in the form of reinforcement steel in this example; however, this is not strictly required and other materials and elongate members of different shapes may be used in other embodiments.

Referring back to FIG. 1, the portable heating assembly 70 includes a pair of inlets extending through respective ones of the side walls of the housing 72 in this example. This is shown in FIG. 1 by inlet 172 extending through side wall 78 of the housing. The inlets are rectangular in this example and are in communication with the interior 85 of the housing. As seen in FIG. 1, includes a pair of inlet covers selectively extendable about the inlet. This is seen by inlet cover 174 hingedly coupled via hinge 176 to outer portion 118 of side wall 78 of the housing 72. Each inlet cover is generally rectangular in shape in this example. As seen in FIG. 6, each inlet cover 174 has a closed position in which the cover encloses its inlet 172 and extends substantially in parallel with its side wall 78. Each inlet cover is moveable from its closed position to a partial open position seen in FIG. 1 in which the inlet cover extends at an angle outwards from its side wall and in which the distal end 178 of the inlet cover is spaced-apart from its side wall.

As seen in FIG. 3, the portable heating assembly 70 includes a grid assembly 179 in this example. The grid assembly includes a grid 180 comprising a plurality of spaced-apart, longitudinally-extending bars 182 and a plurality of spaced-apart, laterally-extending bars 184 coupled to and extending perpendicular to the longitudinally-extending bars in this example. The grid 180 covers the open end 84 of the housing 72. The grid assembly 179 is coupled to and extends between the side walls 76 and 78, front wall 80, and rear wall 82 of the housing. As seen in FIG. 7, longitudinally-extending tubes 164, 166, 168, 170, 183, 185, 189, 191, 195, 197, 201, and 203 are coupled via welding to grid 180 in this example, which is shown in ghost in FIG. 7.

As seen in FIG. 3, the grid assembly 179 includes a pair of flanges 186 and 188 coupled to and extending outwards from side walls 76 and 78 of the housing 72 in this example adjacent to the open end 84 of the housing. The grid assembly includes a flange 190 coupled to and extending outwards from the front wall 80 of the housing 72 in this example adjacent to the open end 84 of the housing. The grid assembly 179 includes a flange 192 coupled to and extending outwards from the rear wall 82 of the housing in this example adjacent to the open end 84 of the housing. Each of the flanges 186, 188, 190 and 192 is generally in the shape of a rectangular prism in this example. The flanges extend about the grid 180 in this case.

As seen in FIG. 6, the portable heating assembly 70 includes a first, or upper reflector plate 194 abutting and extending along the inner portion 106 of the top wall 74 of the housing. The upper reflector plate is generally rectangular in shape in this example. The upper reflector plate 194 extends between the inner portions 120 and 122 of the side walls 76 and 78 of the housing and is interposed between the inner portion of the top wall and tubes 140 and 142 in this example. The tubes function to situate the upper reflector plate in place in this example. As seen in FIG. 7, the upper reflector plate 194 extends between the inner portions 110 and 114 of the front wall 80 and rear wall 82 of the housing 72, respectively. The upper reflector plate extends between and abuts tubes 160 and 162 in this example. The upper reflector plate 196 is thus coupled to and extends along the top wall 74 of the housing 72.

The portable heating assembly 70 includes a second, or lower reflector plate 196 which in this example extends in parallel with and is spaced-apart below upper reflector plate 194. The reflector plates are high-temperature reflective plates in this example. The lower reflector plate is generally rectangular in shape in this example. As seen in FIG. 6, the lower reflector plate 196 extends between the inner portions 120 and 122 of the side walls 76 and 78 of the housing 72. As seen in FIG. 7, the lower reflector plate extends between the inner portions 110 and 114 of the front wall 80 and rear wall 82 of the housing 72, respectively.

As seen in FIG. 7, the portable heating assembly 70 includes a pair of spaced-apart reflector plate mounts, in this example u-shaped brackets 198 and 200 coupled to laterally-extending tubes 167 and 171, respectively. Brackets 198 and 200 abut the inner portions 110 and 114 of the front wall 80 and rear wall 82, respectively, and are shaped to received therewithin peripheral portions 202 and 204 of the lower reflector plate 196. In this manner, the lower reflector plate is secured in place and thus selectively connectable to housing 72 in this example.

As seen in FIG. 7, the housing 72 includes an upper chamber 206 enclosed by the reflector plates 194 and 196. The upper chamber is generally a rectangular prism in shape in this example. The upper chamber 206 is adjacent to the inner portion 106 of the top wall 74 of the housing 72. The upper chamber is in communication with and between upper portions 208 and 210 of the front wall 80 and rear wall 82 of the housing. As seen in FIG. 6, the upper chamber 206 is in communication with and between upper portions 212 and 214 of the side walls 76 and 78 of the housing.

The housing 72 includes a lower chamber 216 adjacent to and spaced below the upper chamber 206. The lower chamber is generally a rectangular prism in shape in this example and is approximately three times larger in volume compared to the upper chamber in this example. The lower reflector plate 196 extends between and divides the upper chamber 206 from lower chamber 216 in this example. The upper and lower chambers are thus thermally isolated from each other at least in part in this example. The lower chamber 216 extends from the lower reflector plate 196 to the open end 84 of the housing 72 in this example. The lower chamber is in communication with and between lower portions 218 and 220 of the side walls 76 and 78 of the housing. As seen in FIG. 7, the lower chamber 216 is in communication with and between lower portions 222 and 224 of the front wall 80 and rear wall 82 of the housing.

As seen in FIG. 5, the portable heating assembly 70 includes a plurality of spaced-apart heating plates, in this example infrared heating plates in the form of a first row 226 of heating plates 228 and 230, a second row 232 of heating plates 234 and 236, a third row 238 of heating plates 240 and 242, and a fourth row 244 of heating plates 246 and 248. As seen in FIG. 7, the heating plates are aligned adjacent to and extend along the open end 84 of the housing 72 in this example. The lower chamber 216 is in communication with the heating plates in this example. As seen with reference to FIGS. 5 and 7, each of the heating plates 228, 230, 234, 236, 240, 242, 246 and 246 is generally rectangular in shape in this example.

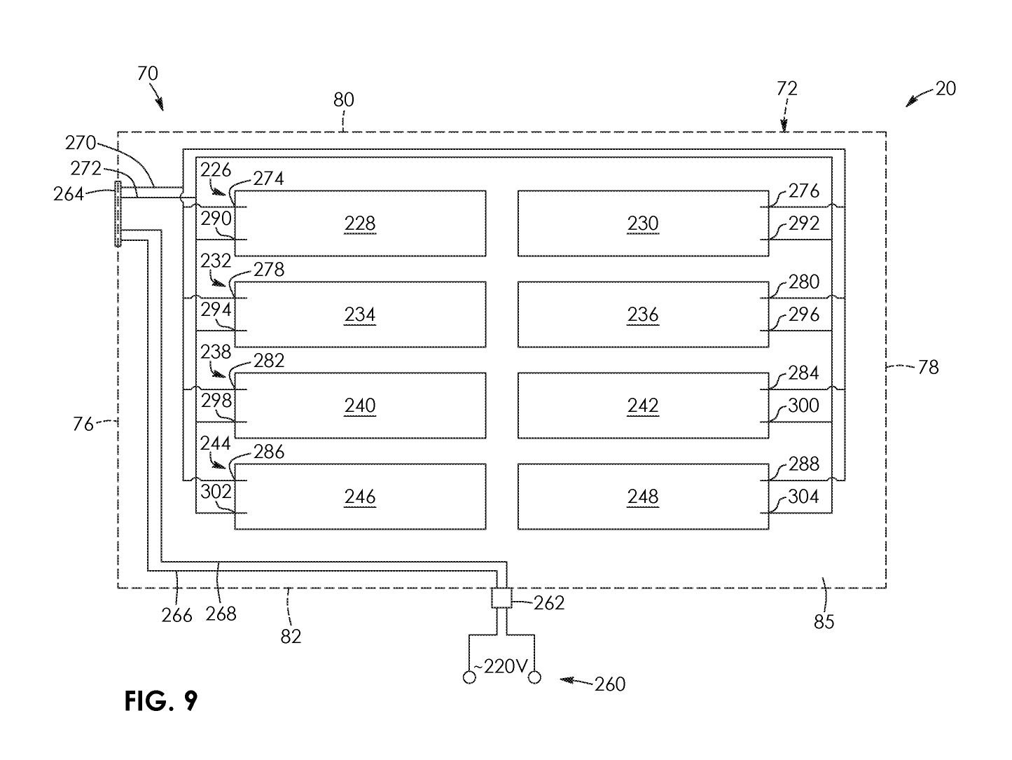

Each of the heating plates is a carbon crystal mica heating plate in this example; however, this is not strictly required and the heating plates may be made of other materials in other examples. The heating plates in this example are manufactured by Beijing Nuan Zhi Yuan Technology Co., Ltd, which has an address of No. 98, Xinyuan Sci-tech Park, Changping, Beijing, China. The heating plates as herein described may be purchased in North America from Smart EPC Ltd., having an address of 25 Evergreen Mount SW, Calgary, Alberta, Canada, T2Y OK1. As seen in FIG. 8, each of the heating plates, as shown by heating plate 230, may comprise a carbon fiber heating layer 231 embedded between thin mica plate sheets 233 and 235 in this example. As seen in FIG. 9, each of the heating plates 230 includes a pair of electrodes, in this example copper electrodes in the form of an input terminal 276 and an output terminal 292. The input and output terminals are in electrical contact with the carbon fiber heating layer 231 seen in FIG. 8.

As seen in FIG. 5, heating plate 228 is positioned adjacent to front wall 80 and side wall 76 of the housing 72 in this example. Heating plate 230 is positioned adjacent to the front wall and side wall 78 of the housing in this example. Heating plate 246 is positioned adjacent to the rear wall 82 and side wall 76 of the housing 72 in this example. Heating plate 248 is positioned adjacent to the rear wall and side wall 78 of the housing in this example. Heating plates 234 and 240 are positioned between heating plates 228 and 246 and are adjacent to side wall 76 of the housing 72 in this example. Heating plates 230 and 248 are positioned between heating plates 236 and 242 and are adjacent to side wall 78 of the housing 72 in this example.

The portable heating assembly 70 includes a pair of spaced-apart mounting brackets for each of its heating plates, as seen in FIG. 8 by mounting brackets 250 and 252 for heating plate 230. Each of the mounting brackets is c-shaped in cross-section in this embodiment and is coupled to its corresponding pair 181 of heating-plate mounting tubes 183 and 185 via welding in this example, as shown by weld 254. The mounting brackets are made of high-temperature resistant polyester damping material in this example; however, this is not strictly required and the brackets may be made of other materials in other examples. Each pair of mounting brackets 250 and 252 is shaped to slidably receive therebetween longitudinally-extending edge portions 256 and 258 of its corresponding heating plate 230. The heating plates are thus selectively received within and removable from their mounting brackets. In this manner and referring to FIG. 7, the heating plates, as shown by heating plates 230, 236, 242, 248 in FIG. 7, couple to the grid 180. The assembly 70 includes a plurality of reinforcement elements, in this example bars which are rectangular in cross-section. Each of the bars is interposed between respective pairs of mounting brackets, as seen by bar 237 interposed between brackets 183 and 185 in FIG. 8. The bars couple to and extend between the inner portions 120 and 122 of the side walls 76 and 78 seen in FIG. 6 in this example.

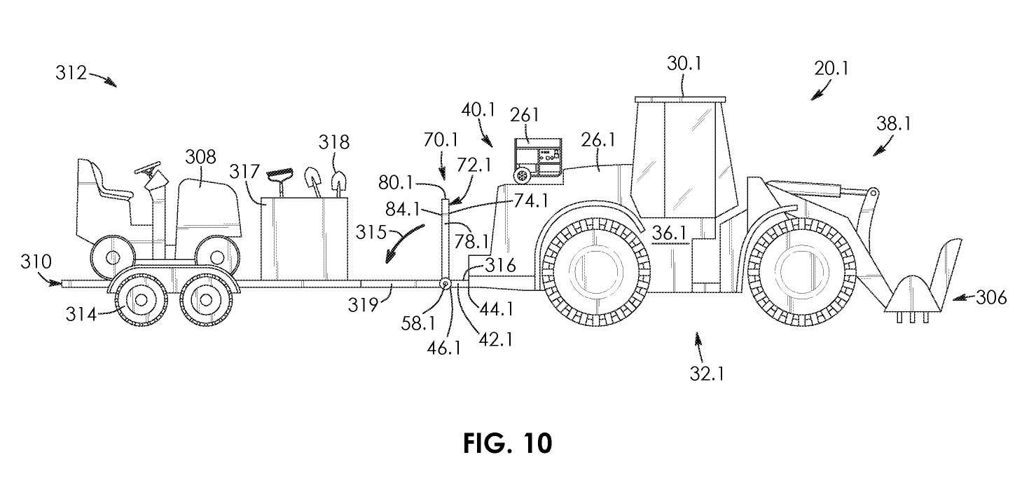

As seen in FIG. 9, the portable heating assembly 70 includes a power source 260, having an input power of 220 V, a rated power of 5 KW and a relatively low maximum power of 10 KW in this example. The power source may be in the form of a portable electrical generator, such as portable generator 261 shown in FIG. 10 coupled to the body 26.1 of vehicle 20.1 adjacent to the top 30.1 thereof. The generator may be diesel operated, for example, and generates electricity therefrom.

Referring back to FIG. 9, the power source 260 is connectable to a plug 262 mounted on rear wall 82 of the housing 72 in this example. The assembly 70 further includes a temperature controller 263, a temperature sensor in this example a rheostat 264 and a temperature transmitter 265 which interfaces between the controller and rheostat. These are mounted to the side wall 76 of the housing in this example, with the rheostat being in communication with the interior 85 of the housing. The power source 260 and the temperature controller 263, rheostat 264 and temperature transmitter 265 are electrically coupled together via conduits, in this example wiring 266 and 268 positioned within the interior 85 of the housing 72. The assembly 70 further includes a pair of conduits, in this example wiring 270 and 272 electrically coupled to wiring 266 and 268, respectively, with the controller 263 being connected therebetween. Selective rotation of the rheostat controls the amount of current passing through wiring 266 and 268.

Wiring 270 is coupled to and thus supplies power to input terminals 274, 276, 278, 280, 282, 284, 286 and 288 of the heating plates 228, 230, 234, 236, 240, 242, 246, and 248, respectively. Wiring 272 is coupled to output terminals 290, 292, 294, 296, 298, 300, 302, and 304 of the heating plates 228, 230, 234, 236, 240, 242, 246, and 248, respectively. The heating plates are thus connected in parallel with each other and are connectable to power source 260 for emitting infrared energy.

Referring to FIG. 1, this infrared energy may be used for renewal and repair of road 22 made of asphalt 24. As seen in FIG. 6, lower reflector plate 196 functions to contain upward directed infrared energy with the lower chamber 216 and reflect the infrared energy back downwards towards the road 22 seen in FIG. 1. In this manner, the reflector plates may function to provide directional control for the heat radiation, thereby promoting dissipation of heat from the open end 84 of the housing. The plates thus minimize heat loss and inhibit excess heat accumulation. Referring back to FIG. 6, upper reflector plate 194 functions to further reflect and direct downwards any infrared energy which may pass upwards through the lower chamber. As seen in FIG. 6, the combination of upper reflector plate 194 and lower reflector plate 196 may reflect approximately 90% of upward-directed heat downwards to the road. The heat resulting from the portable heating assembly 70 so configured may reach up to six inches deep through the road, for example. The assembly may raise the temperature of the road to about 200 degrees Celsius in about 10 minutes, in one example. The wool 88, 93, 95, 98 and 100 of the assembly 70 may function to control heat radiation and inhibit heat loss.

Thereafter, an asphalt rejuvenating processor, such as processor 306 for vehicle 20.1 seen in FIG. 10 coupled to rear end 38.1 thereof, may process, screed and rejuvenate the existing asphalt so heated by the portable heating assembly 70. Additives, such as recycled asphalt pavement (RAP) material, may also be disposed on the road to serve as agents for seamlessly fusing damaged areas of existing asphalt being processed.

A self-propelled compaction device, in this example a vibratory drum roller, such as drum roller 308 seen in FIG. 10 stored on a trailer 310 of the vehicle 20.1 when not in use, may next compact the asphalt so rejuvenated by the processor 306. The generator 261 functions to power the portable heating assembly 70 seen in FIG. 1 and the asphalt rejuvenating processor, for example processor 306 for vehicle 20.1 in FIG. 10.

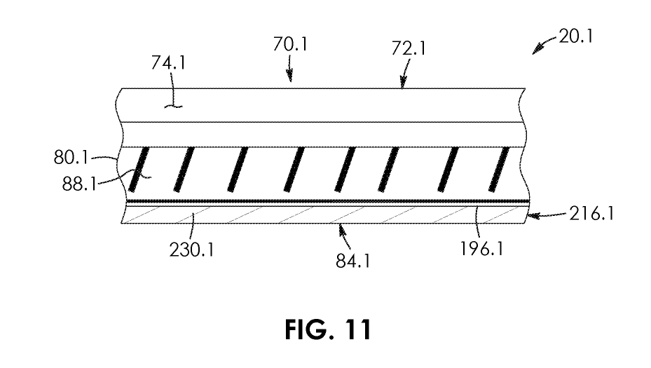

FIGS. 10 and 11 show vehicle 20.1 and a portable heating assembly 70.1 therefor according to a second aspect. Like parts have like numbers and functions as the vehicle 20 and assembly 70 shown in FIGS. 1 to 9 with the addition of decimal extension “.1”. Vehicle 20.1 and portable heating assembly 70.1 are the same as described for vehicle 20 and portable heating assembly 70 shown in FIGS. 1 to 9 with the following exceptions.

As mentioned above, vehicle 20.1 further includes portable generator 261, asphalt rejuvenating processor 306, vibratory drum roller 308, and a trailer 310 upon which the roller may be stored. The vehicle so configured may ensure that its system 312 for rejuvenating asphalt is fully portable. The trailer 310 includes a plurality of ground-engaging wheels 314 and is coupled to end 40.1 of the vehicle 20.1 via elongate arm 42.1, which in this example is part of a trailer hitch 316 in this example. The vehicle further includes a storage receptacle 317 storable on the trailer and within which other various tools may be stored such as shovels 318, rakes 320 and the like.

As seen in FIG. 11, the portable heating assembly 70.1 in this example comprises only one reflector plate 196.1 and a single chamber 216.1. The heating plates, as shown by heating plate 230.1, are made of ceramic in this embodiment. As seen in FIG. 10, the arm 42.1 which couples the heating assembly 70.1 to the body 26.1 of the vehicle 20.1 extends substantially horizontally in this example. The portable heating assembly 70.1 pivotally is connected to the distal end 46.1 of the arm and has a stored position seen in FIG. 10 in which the heating assembly extends substantially vertically. Upon the vehicle 20.1 arriving at the road site, trailer 310 is removable from the rest of the vehicle 20.1 Thereafter, the portable heating assembly 70.1 may be lowered downwards, as shown by arrow of numeral 315, from its stored position to a deployed position seen in FIG. 11. The portable heating assembly extends within recess 319 of the trailer 310 seen in FIG. 10 when in the deployed position in this example. As seen in FIG. 11, the portable heating assembly 70.1 extends substantially horizontally in its deployed position.

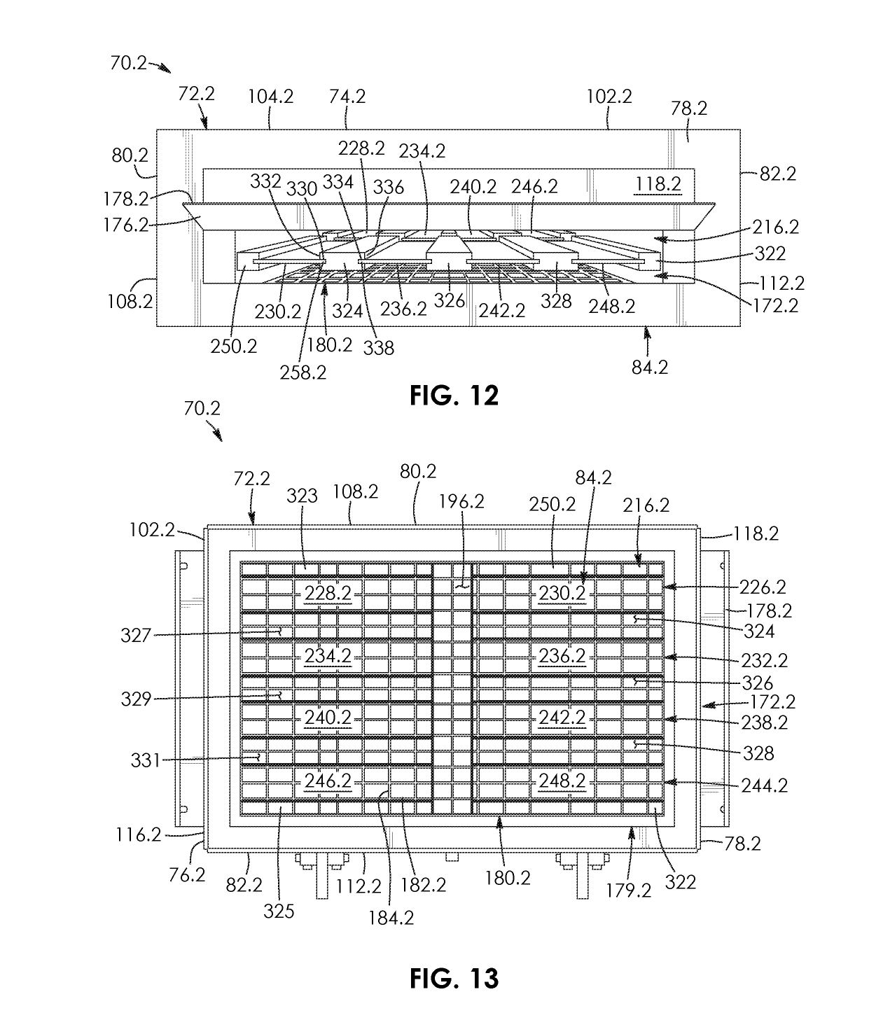

FIGS. 12 and 13 show a portable heating assembly 70.2 according to a third aspect. Like parts have like numbers and functions as the portable heating assembly shown in FIGS. 1 to 9 with the addition of decimal extension “.2”. Portable heating assembly 70.2 is the same as described for portable heating assembly 70 for vehicle 20 shown in FIGS. 1 to 9 with the following exceptions.

In this embodiment, heating plate mounting tubes are not provided. As seen in FIG. 13, the assembly 70.2 includes peripheral mounting brackets 250.2, 322, 323, and 325. Brackets 250.2 and 323 align adjacent to front wall 80.2 of the housing 72.2. Brackets 322 and 325 align adjacent to rear wall 82.2 of the housing. Brackets 323 and 325 align adjacent to side 76.2 of the housing 72.2. Brackets 250.2 and 322 align adjacent to side wall 78.2 of the housing. The peripheral mounting brackets are u-shaped in section in this example, as shown in FIG. 12 by mounting brackets 250.2 and 322

Referring to FIG. 13, the assembly 70.2 further includes inner mounting brackets 324, 326, and 328 positioned between brackets 250.2 and 322 and inner mounting brackets 327, 329, and 331 positioned between brackets 323 and 325. Referring to FIG. 12, each of the inner mounting brackets are I-shaped in section in this example, with slots to receive peripheral portions of heating plates therein. This is shown in FIG. 12 for bracket 324 by slot 330 at side 332 thereof which receives peripheral portion 258.2 of heating plate 230.2 and slot 334 at side 336 of the bracket 324 which receives peripheral portion 338 of heating plate 236.2.

The tubes are herein described may also be referred to as ribs. Also, while the tubes have been described as coupling to the housing 72 via welding, the tubes may couple to the housing in other manners in other examples.

It will be appreciated that many variations are possible within the scope of the invention described herein. It will also be understood by someone skilled in the art that many of the details provided above are by way of example only and are not intended to limit the scope of the invention which is to be determined with reference to at least the following claims.

What is claimed is:

1. A portable heating assembly for in situ asphalt road renewal, the assembly comprising:
a housing including a top wall and a plurality of side walls coupled to and extending downwards from the top wall, the top and side walls including insulating material therewithin, and the housing having an open end spaced-apart below the top wall; and
at least one heating plate coupled to the housing and in communication with the open end of the housing, the heating plate being between the side walls.

2. The assembly as claimed in claim 1 wherein the heating plate is aligned adjacent to the open of end of the housing and extends along the open end of the housing.

3. The assembly as claimed in claim 1 wherein the housing has an interior surrounded by the top and side walls thereof and wherein the assembly further includes a reflector plate coupled to and extending between the side walls of the housing, the reflector plate being spaced-apart below the top wall of the housing.

4. The assembly as claimed in claim 1 further including a first reflector plate coupled to and extending along the top wall of the housing and coupled to and extending between the side walls of the housing and a second reflector plate coupled to and extending between the side walls of the housing, the second reflector plate being spaced-apart below the first reflector plate.

5. The assembly as claimed in claim 1 wherein the housing includes an upper chamber adjacent to the top wall and upper portions of the side walls thereof and a lower chamber in communication with the heating plate and the open end and lower portions of the side walls of the housing, and wherein the assembly further includes a reflector plate extending between the upper and lower chambers.

6. The assembly as claimed in claim 5 wherein the upper and lower chambers are rectangular and wherein the assembly further includes a grid extending along the open end of the housing and coupled to and extending between the side walls of the housing, the heating plate mounting to said grid.

7. The assembly as claimed in claim 1 further including at least one inlet and at least one inlet cover selectively extendable over said inlet, the inlet extending through one of the side walls of the housing and the inlet cover being hingedly coupled to said one of the side walls.

8. The assembly as claimed in claim 1 further including a pair of spaced-apart mounting brackets operatively coupled to the housing and between which the heating plate is selectively received and removable therefrom, wherein the housing is generally rectangular, and wherein the heating plate is rectangular, is connectable to a power source and emits infrared energy.

9. The assembly as claimed in claim 8 wherein the brackets are c-shaped in cross-section.

10. The assembly as claimed in claim 8 further including additional heating plates and additional mounting brackets operatively coupling the heating plates to the housing, at least some of the mounting brackets being I-shaped in cross-section.

11. The assembly as claimed in claim 8 further including additional heating plates and additional mounting brackets operatively coupling the heating plates to the housing, at least one of the mounting brackets having a first side with a slot extending therein for receiving a peripheral portion of a first one of the heating plates and a second side with a slot extending therein for receiving a peripheral portion of a second one of the heating plates.

12. The assembly as claimed in claim 1, wherein the heating plate includes a pair of mica plate sheets, a carbon fiber heating layer embedded between said mica plate sheets and a pair of electrodes electrically coupled to said carbon fiber heating layer.

13. The assembly as claimed in claim 1 wherein the heating plate is a carbon crystal mica heating plate.

14. The assembly as claimed in claim 1 wherein the heating plate is made of ceramic.

15. A vehicle for in situ asphalt road renewal, the vehicle having a front end and a rear end and comprising:
a portable heating assembly, the assembly comprising:
a housing including a top wall and a plurality of side walls coupled to and extending downwards from the top wall, the top and side walls including insulating material therewithin, and the housing having an open end spaced-apart below the top wall; and
at least one heating plate coupled to the housing and in communication with the open end of the housing, the heating plate being between the side walls;
the portable heating assembly being coupled to a first one of said ends of the vehicle;
an asphalt rejuvenating processor for rejuvenating asphalt heated by the portable heating assembly, the processor being coupled to a second one of said ends of the vehicle; and
a portable generator functioning to power the portable heating assembly and asphalt rejuvenating processor.

16. The vehicle as claimed in claim 15, further including a trailer coupled to one of said ends of the vehicle and a self-propelled compaction device for compacting asphalt so rejuvenated, the compaction device selectively received by said trailer.

17. A portable heating assembly for in situ asphalt road renewal, the assembly comprising:
a housing having an open end; and
at least one carbon crystal mica heating plate coupled to and enclosed in part by the housing, the heating plate being connectable to a power supply and being in communication with the open end of the housing.

18. The assembly as claimed in claim 17, wherein the housing includes a double-shell wall structure and insulation disposed within said wall structure and wherein the assembly further includes a plurality of spaced-apart strengthening ribs coupled to inner and outer surfaces of the housing.

19. The assembly as claimed in claim 18, the housing having an interior and wherein the assembly further includes:
high-temperature reflective plates coupled to and disposed within the interior of the housing;
bracket slots coupled to the wall structure and positioned below the reflective plates;
additional heating plates, the heating plates being connected in parallel to each other, each of the heating plates being embedded in respective ones of the bracket slots; and
a temperature transmitter installed on the outer surface of the housing, the temperature transmitter being connected in series with the heating plates.

20. The portable heating assembly as claimed in claim 17 for use in combination with a vehicle for in situ asphalt road renewal.
